(19) United States
(12) Patent Application Publication
(10) Pub. No.: US 2008/0186281 A1
(43) Pub. Date: Aug. 7, 2008

(54) Device having display buttons and display method and medium for the device

(75) Inventors: Byung-seok Soh, Hwaseong-si (KR); Seong-woon Kim, Yongin-si (KR); Chang-kyu Choi, Seongnam-si (KR); Jun-ho Park, Hwaseong-si (KR); Kwon-ju Lee, Yongin-si (KR); Sun-gi Hong, Yongin-si (KR); Kwang-il Hwang, Seoul (KR); Jung-hyun Shim, Seongnam-si (KR); Yeun-bae Kim, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/590,828

(22) Filed: Nov. 1, 2006

(30) Foreign Application Priority Data
Nov. 1, 2005 (KR) 10-2005-0103822
Dec. 23, 2005 (KR) 10-2005-0129005
Jul. 25, 2006 (KR) 10-2006-0069976

(51) Int. Cl. G06F 3/041

(52) U.S. Cl. 345/173

(57) ABSTRACT

A display method performed in a device having a plurality of buttons includes sensing a touch to the device, and displaying a plurality of images on the plurality of buttons based on length of time of the sensed touch. Accordingly, the convenience to a user when operating the buttons increases.

### CROSS-REFERENCE TO RELATED APPLICATIONS

This application claims the benefit of Korean Patent Application No. 10-2005-0103822, filed on Nov. 1, 2005, 10-2005-0129005, filed on Dec. 23, 2005, and 10-2006-0069976, filed on Jul. 25, 2006 in the Korean Intellectual Property Office, the disclosure of which is incorporated herein in its entirety by reference.

### BACKGROUND OF THE INVENTION

1. Field of the Invention

The present invention relates to a device such as a cellular phone, and more particularly, to a device having image display buttons and a display method and medium for the device.

2. Description of the Related Art

In general, a device, such as a cellular phone, has a plurality of buttons. A user of the device selects a specific function from among various available functions, e.g., a phone call function, a short message editing and sending function, and a video file replay function, from the device by pressing the plurality of buttons, and therefore the device performs the selected specific function.

Thus, if the number of functions available in the device increases, the user who wants to select a specific function must perform a greater number of button pressing operations. A recent trend is cellular phones performing various functions, such as a phone call function, a music replay function, a video file replay function, and an Internet surfing function. Such recent trend functions have become a highly competitive market as compared with cellular phones, which only perform a simple phone call function. As such, a current button system is becoming complicated.

In addition, if the number of functions available in device such as a cellular phone increases, the number of functions of each button increases, and thus, the size of the letters engraved on the surface of each button that represent the functions of the button is smaller, whereby a person having poor sight may have difficulties when operating the button.

In addition, a method of installing a large number of buttons on a device such as a cellular phone in order to reduce the number of inputs of a button of a user can be considered. However, according to a recent trend to miniaturize products, the size of the buttons of the device must be smaller, and thus, it may be difficult to operate the buttons.

### SUMMARY OF THE INVENTION

Additional aspects, features, and/or advantages of the invention will be set forth in part in the description which follows and, in part, will be apparent from the description, or may be learned by practice of the invention.

The present invention provides a display method in which when a device is touched for a predetermined time, a plurality of images that are touch sensitive and are path structured are displayed on a plurality of buttons included in the device.

The present invention also provides a device having a plurality of display buttons that display a plurality of images that are based on paths and touch sensitive when the device is touched for a predetermined time.

The present invention also provides a computer readable recording medium storing a computer readable program for executing a display method in which when a device is touched for a predetermined time, a plurality of images determined based on paths and touch sensitive are displayed on a plurality of buttons included in the device.

According to an aspect of the present invention, there is provided a display method performed in a device having a plurality of buttons, the method comprising: sensing a touch to the device including sensing locations where the touch has occurred; and displaying a plurality of images on the plurality of buttons, wherein displaying the plurality of images on the plurality of buttons includes analyzing a trajectory of the sensed locations; and displaying a plurality of images, which are indicated by image data corresponding to the analyzed trajectory from among predetermined image data, on the plurality of buttons.

According to another aspect of the present invention, there is provided a device comprising: a sensor to sense a touch to the device wherein the sensor senses locations where the touch has occurred; a plurality of buttons to display a plurality of images in response to a control signal; and a controller to generate the control signal for commanding the display of images on the plurality of buttons, wherein the controller includes a trajectory analyzer to analyze a trajectory of the sensed locations; and a display controller to generate the control signal for commanding the display of images corresponding to the analyzed trajectory.

According to another aspect of the present invention, there is provided at least one computer readable medium storing instructions that control at least one processor to perform a display method in a device having a plurality of buttons, the method comprising: sensing a touch to the device including sensing locations where the touch has occurred; and displaying a plurality of images on the plurality of buttons, wherein displaying the plurality of images on the plurality of buttons includes analyzing a trajectory of the sensed locations; and displaying a plurality of images, which are indicated by image data corresponding to the analyzed trajectory from among predetermined image data, on the plurality of buttons.

### BRIEF DESCRIPTION OF THE DRAWINGS

These and/or other aspects and advantages of the invention will become apparent and more readily appreciated from the following description of exemplary embodiments, taken in conjunction with the accompanying drawings of which:

FIG. 1 is a block diagram for explaining a device having display buttons according to an exemplary embodiment of the present invention;

FIG. 2 illustrates a flip-type cellular phone having display buttons according to an exemplary embodiment of the present invention;

FIGS. 3A through 3D are illustrations of a sensing unit illustrated in FIG. 1, according to an exemplary embodiment of the present invention;

FIGS. 4A through 4E are reference diagrams for explaining a display principle according to an exemplary embodiment of the present invention;

FIGS. 5A through 5G are reference diagrams for explaining a process of sending a short message using the cellular phone illustrated in FIG. 2, according to an exemplary embodiment of the present invention;

FIG. 6 is a reference diagram for explaining a browsing process using the cellular phone illustrated in FIG. 2, according to an exemplary embodiment of the present invention;

FIGS. 7A and 7B are illustrations displayed by magnifying an image selected from among a plurality of images displayed on a plurality of buttons of the cellular phone illustrated in FIG. 2, according to an exemplary embodiment of the present invention; and

FIG. 8 is a flowchart illustrating a display method according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a device having display buttons and a display method and medium for the device are described with reference to the attached drawings. Examples of the device include a cellular phone, personal digital assistant, MP3 player, digital camera, portable media player, and portable game player. However, it is understood that the present invention is also applicable to any device with which display buttons can be used.

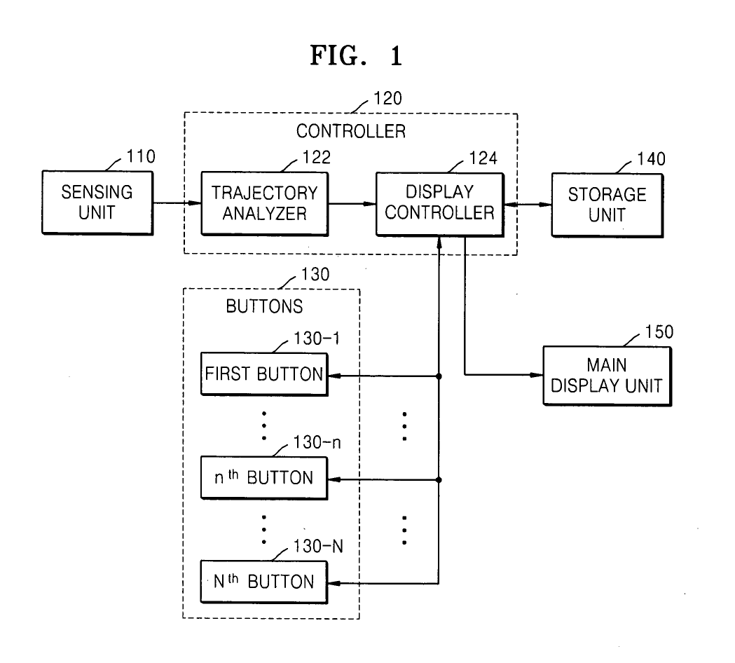

FIG. 1 is a block diagram for explaining a device having display buttons according to an exemplary embodiment of the present invention. Referring to FIG. 1, the device includes a sensing unit (sensor) 110, a controller 120, a plurality of buttons 130, a storage unit 140, and a main display unit 150.

The sensing unit 110, the controller 120, the plurality of buttons 130, and the main display unit 150 may be included in the device. However, the storage unit 140 can be included in the device or connected to the device via a network.

The sensing unit 110 senses a touch to the device. This touch to the device may be a touch from a part of the body of a user, e.g., a fingertip, and may also stem from a touch from an object, e.g., a pen being used by the user on the device. For the convenience of the description, hereinafter, it is assumed that the touch to the device is a touch from the fingertip of the user.

The sensing unit 110 may sense the fact that something directly touches the device as a touch. In another way, the sensing unit 110 may sense the fact that something approaches the surface of the device within a predetermined distance, e.g., several millimeters, as a touch.

The sensing unit (sensor) 110 can be realized with a plurality of touch sensors. Each touch sensor generates a touch signal every time the sensing unit 110 senses a touch. In the present exemplary embodiment, the touch signal may contain information on a location of the touch sensor, which has generated the touch signal, on the device. Thus, the sensing unit 110 can sense a touched location. In this case, the location may be a location on the device.

The controller 120 generates a control signal. Here, the control signal is a signal for commanding a display of a plurality of images containing image data corresponding to a result sensed for a predetermined time from among prepared image data. That is, if the sensing unit 110 continuously senses the touch for the predetermined time, the controller 120 commands the main display unit 150 to display the plurality of images corresponding to the result sensed for the predetermined time.

The predetermined time may be a value within a predetermined range. Here, the upper limit and the lower limit of the range can be previously set. For example, the lower limit may be a time required for the user to release the fingertip of the user from a certain button immediately after touching the certain button with the fingertip. This required time can be previously calculated according to experiences and experiments. The upper limit may be a time required for the user to touch buttons continuously once in a certain direction, wherein the touch buttons are arranged in a matrix form and a certain direction can be in a diagonal direction. This required time can also be previously calculated according to experiences and experiments.

In exemplary embodiments of the present invention, the predetermined time indicates a time required for the sensing unit 110 to continuously sense a touch. Here, the predetermined time has the upper limit and the lower limit. In order for the sensing unit 110 to continuously sense a touch, the user must continuously touch the device. Here, the continuous touch may indicate that the user continuously touches the same location on the device. In this case, the sensing unit 110 continuously generates a touch signal. In another way, the continuous touch may indicate that the user touches a certain section of the device by rubbing the certain section. In this case, the sensing unit 110 continually generates the touch signal only if the sensing unit 110 is realized with a plurality of touch sensors or continuously generates the touch signal only if the sensing unit 110 is realized with a single touch sensor. In order to determine whether the continually generated touch signal is a continuous touch, an interval determined when the generation of the touch signal stops and when the generation of the touch signal restarts must be less than the predetermined time.

The controller 120 may include a trajectory analyzer 122 and a display controller 124.

The trajectory analyzer 122 analyzes a trajectory of sensed locations, which is formed for a predetermined time. For the convenience of the description, it is assumed that the trajectory analyzer 122 analyzes a touch direction. That is, it is assumed that the trajectory analyzer 122 analyzes a direction of sensed locations for the predetermined time.

The display controller 124 generates a control signal. Here, the control signal is a signal for commanding the main display unit 150 to display the plurality of images containing image data corresponding to the analyzed trajectory of sensed locations.

The control signal generated by the controller 120 may be generated in correspondence to only a result sensed for the predetermined time or generated in correspondence to the result sensed for the predetermined time and to images currently displayed on a plurality of buttons 130.

The plurality of buttons 130 displays the plurality of images, e.g., N images, in response to the control signal. To do this, the plurality of buttons 130-1 through 130-N include a sub-display unit (not shown) displaying the plurality of images in response to the control signal. The sub-display unit may be realized using a single display panel.

The storage unit 140 stores image data. In detail, the prepared image data is the image data stored in the storage unit 140. In more detail, the storage unit 140 stores image data based on the result sensed for the predetermined time.

Thus, the controller 120 reads image data corresponding to the result sensed for the predetermined time from among the prepared image data from the storage unit 140, generates a control signal commanding the display of the plurality of images corresponding to the read image data, and outputs the read image data to the plurality of buttons 130. Then, the plurality of buttons 130 display the plurality of images.

The main display unit 150 can be an interface for performing a display function. The main display unit 150 can operate as only an output device for performing the display function or operate as an input/output device such as a touch screen.

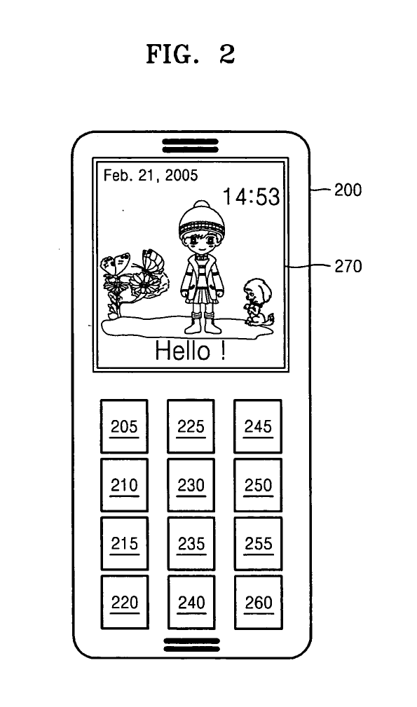

FIG. 2 illustrates a flip-type cellular phone 200 having display buttons according to an exemplary embodiment of the present invention.

That is, FIG. 2 illustrates a case where the device according to an exemplary embodiment of the present invention is implemented with the flip-type cellular phone 200. The flip-type cellular phone 200 includes first through twelfth buttons 205, 210, 215, 220, 225, 230, 235, 240, 245, 250, 255, and 260, respectively. Herein, all of the first through twelfth buttons 205, 210, 215, 220, 225, 230, 235, 240, 245, 250, 255, and 260 can have the display function. The flip-type cellular phone 200 includes a display window 270. The display window 270 is a possible example of the main display unit 150 illustrated in FIG. 1.

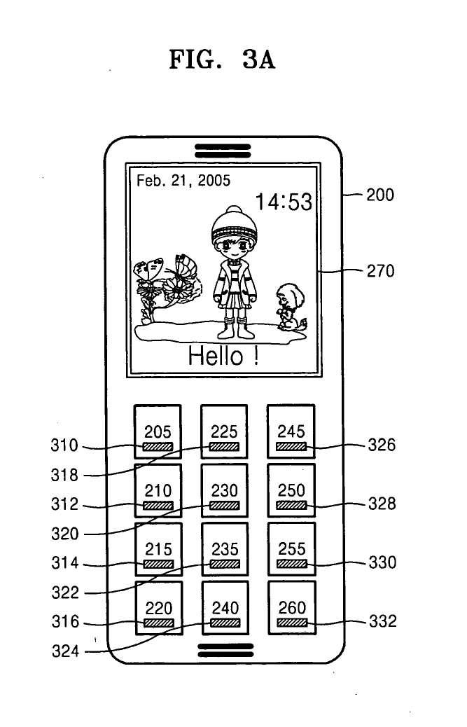

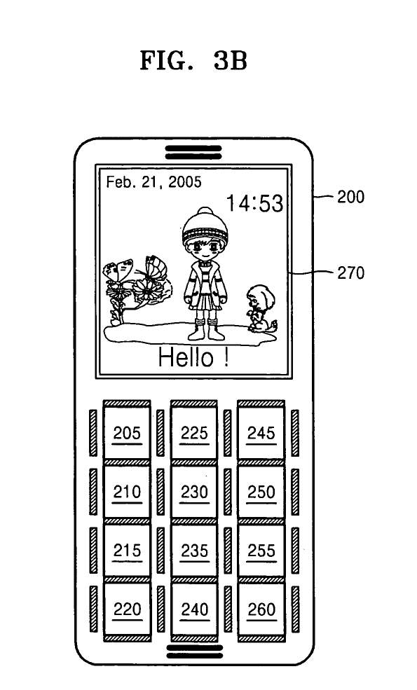

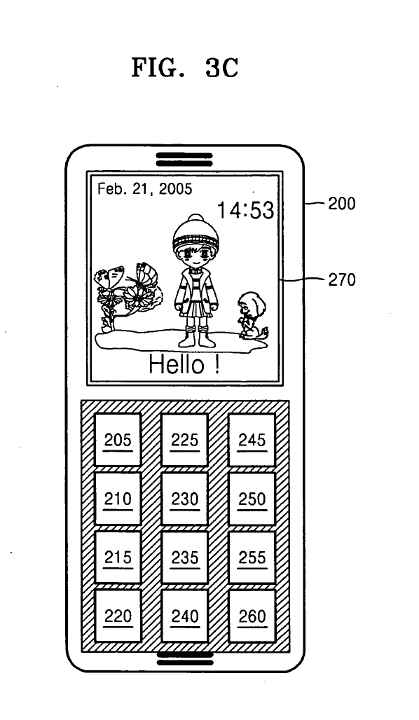

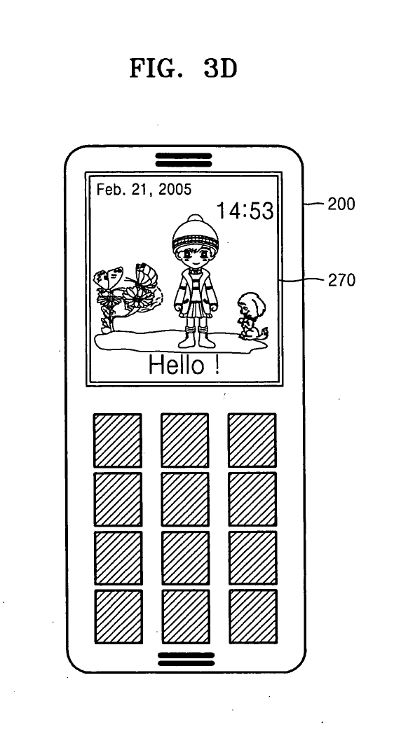

FIGS. 3A through 3D are illustrations of the sensing unit 110 illustrated in FIG. 1 using the flip-type cellular phone 200 illustrated in FIG. 2, according to an exemplary embodiment of the present invention.

In FIGS. 3A through 3D, shadow areas indicate a plurality of touch sensors 310, 312, 314, 316, 318, 320, 322, 324, 326, 328, 330, and 332. Even though the touch sensors 310, 312, 314, 316, 318, 320, 322, 324, 326, 328, 330, and 332 are illustrated in FIG. 3A, the touch sensors 310, 312, 314, 316, 318, 320, 322, 324, 326, 328, 330, and 332 are not labeled in FIGS. 3B through 3D even though the touch sensors 310, 312, 314, 316, 318, 320, 322, 324, 326, 328, 330, and 332 are present.

The sensing unit 110 illustrated in FIG. 1 can be realized with the plurality of touch sensors 310, 312, 314, 316, 318, 320, 322, 324, 326, 328, 330, and 332 as illustrated in FIGS. 3A, 3B, and 3D or realized with a single touch sensor as illustrated in FIG. 3C.

In addition, the touch sensors 310, 312, 314, 316, 318, 320, 322, 324, 326, 328, 330, and 332 can be integrate with the first through twelfth buttons 205, 210, 215, 220, 225, 230, 235, 240, 245, 250, 255, and 260 as one unit as illustrated in FIG. 3A or 3D or included in a frame of the flip-type cellular phone 200 as illustrated in FIG. 3B or 3C.

If the touch sensors 310, 312, 314, 316, 318, 320, 322, 324, 326, 328, 330, and 332 are realized as illustrated in FIG. 3A or 3D, the touch sensors 310, 312, 314, 316, 318, 320, 322, 324, 326, 328, 330, and 332 may be formed of a transparent material.

For the convenience of the description, it is assumed that the touch sensors 310, 312, 314, 316, 318, 320, 322, 324, 326, 328, 330, and 332 are realized as illustrated in FIG. 3A.

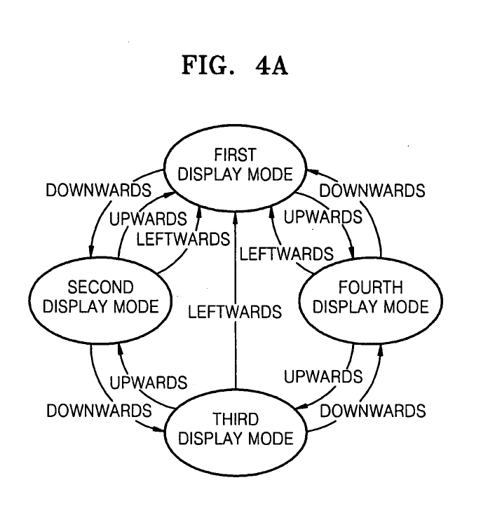

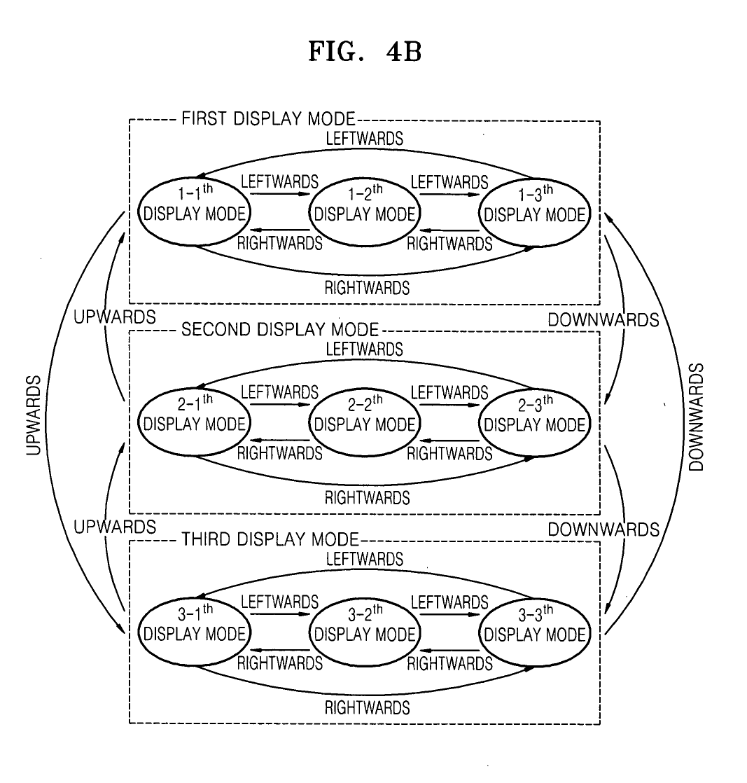

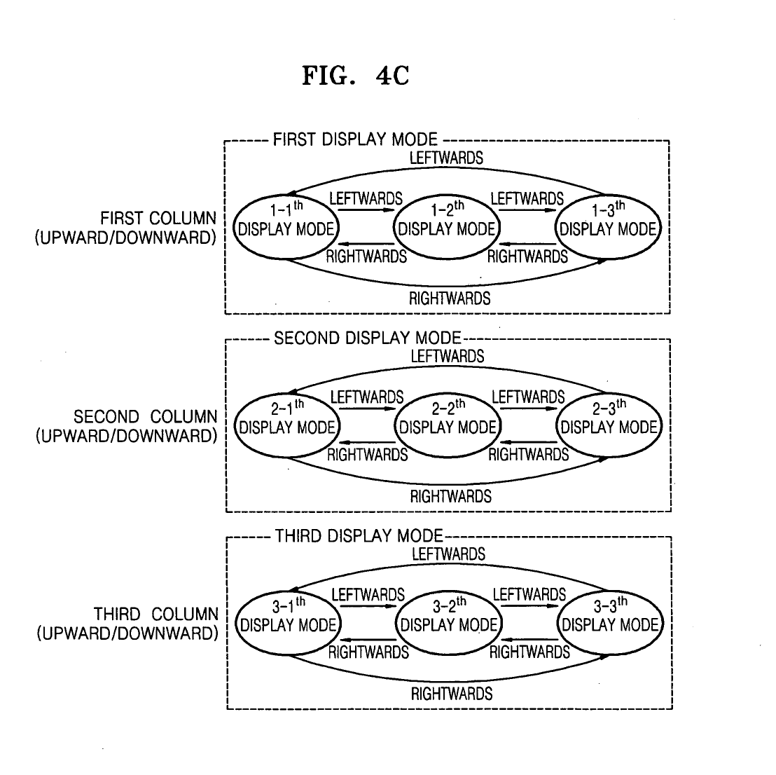

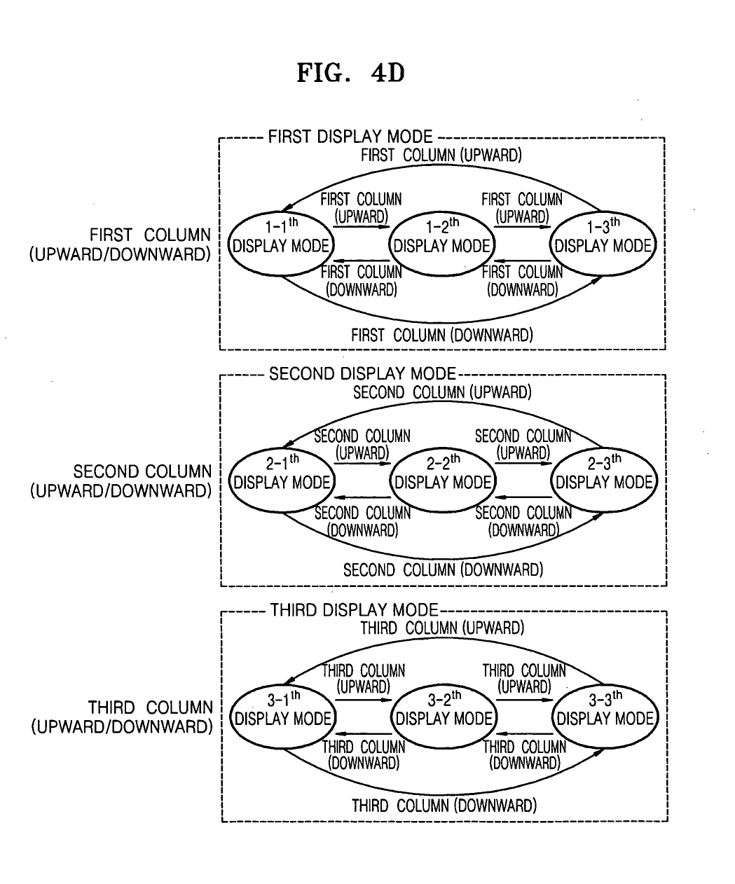

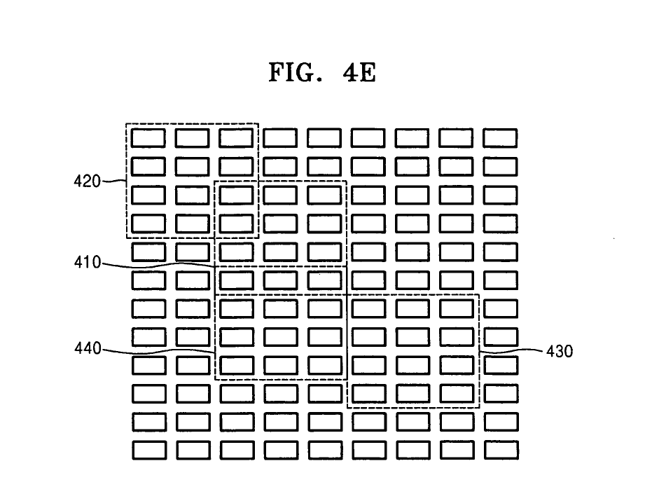

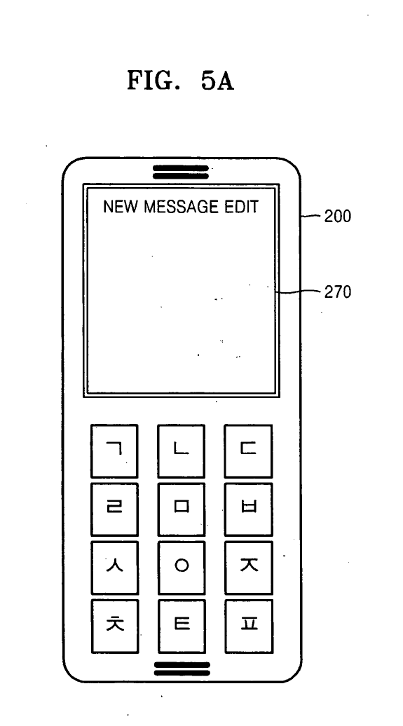

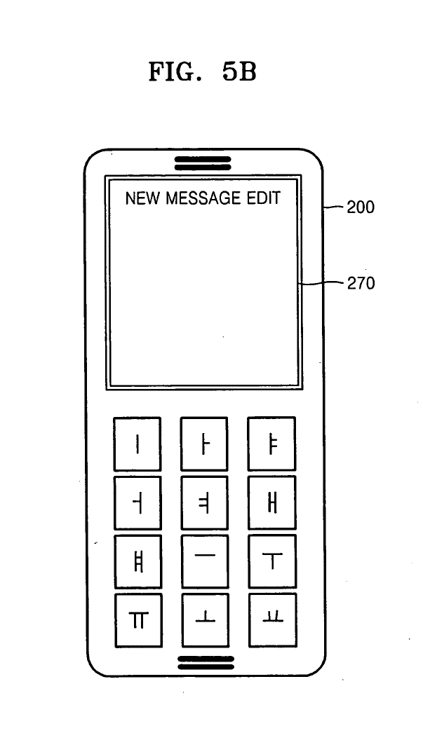

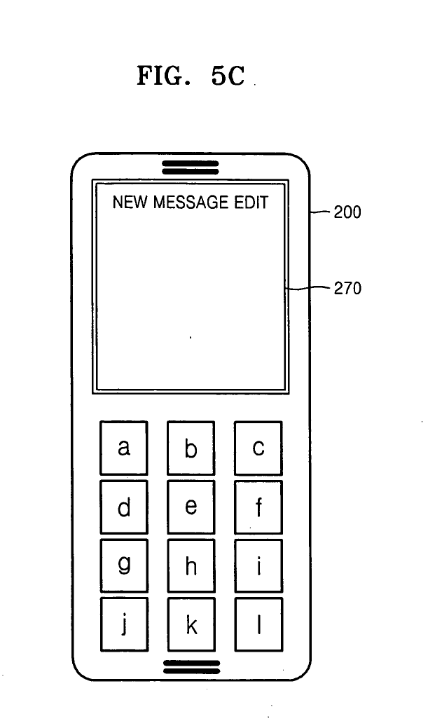

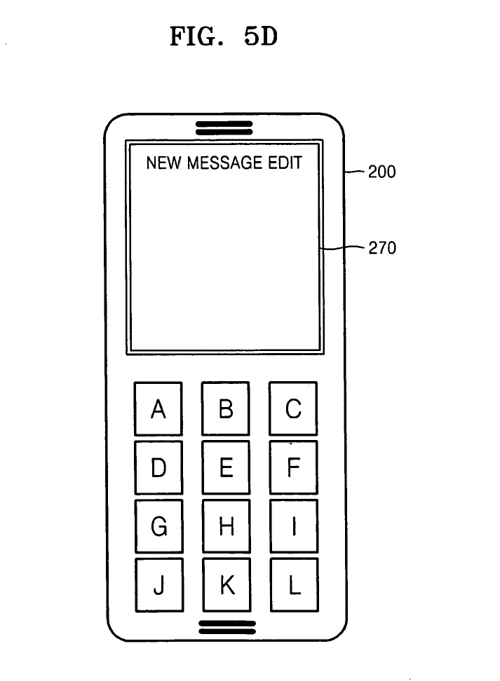

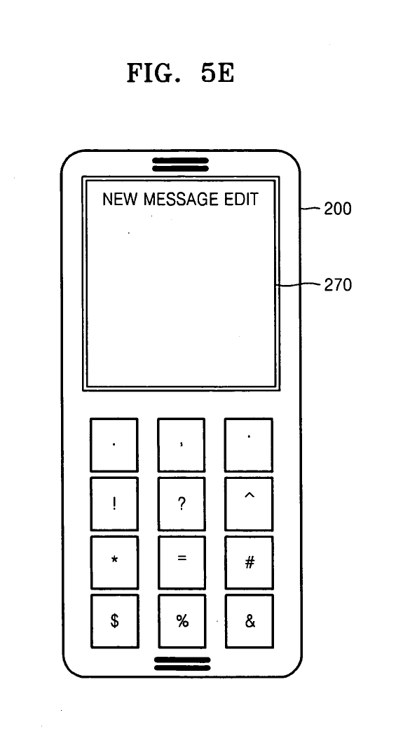

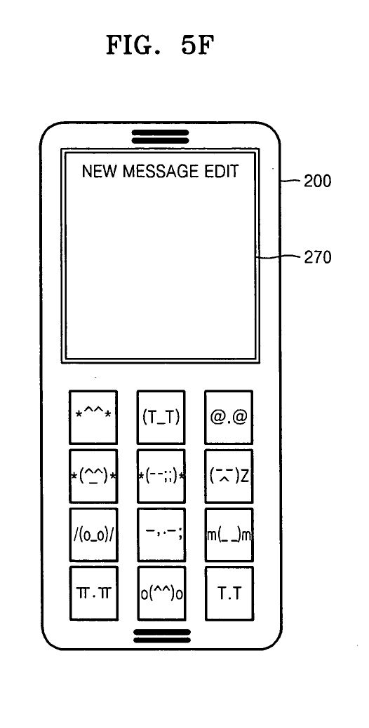

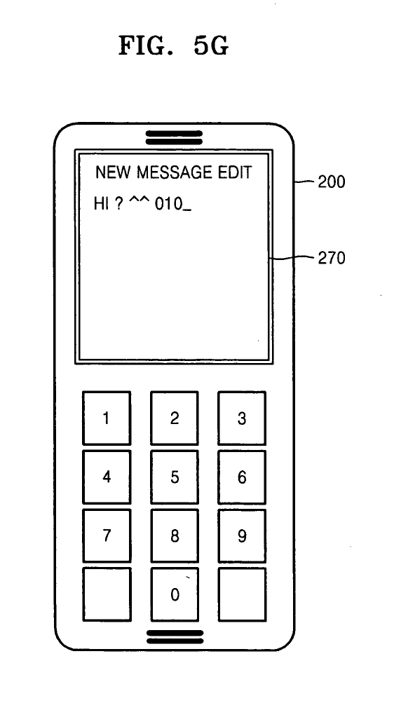

FIGS. 5A through 7 are reference diagrams for explaining operations of the controller 120 through the main display unit 150 illustrated in FIG. 1 using the flip-type cellular phone 200 illustrated in FIG. 2. The description of FIGS. 5A through 7 will be performed after various illustrations explaining a display principle are described with reference to FIGS. 4A through 4E.

FIGS. 4A through 4E are reference diagrams of first through fifth illustrations for explaining a display principle according to an exemplary embodiment of the present invention.

In FIGS. 4A through 4E, the storage unit 140 stores image data based on a display mode. There are various display modes to which the plurality of images displayed by the plurality of buttons 130 through 130-N can belong, and information on the various display modes is stored in both the controller 120 and the storage unit 140.

If image data is stored based on a display mode, the controller 120 determines the display mode corresponding to a result sensed for the predetermined time (for example, an analyzed trajectory) and reads image data corresponding to the determined display mode from the storage unit 140. In this case, if the plurality of image data belonging to the determined display mode are stored in the storage unit 140, the controller 120 reads a single image data from among the stored image data. The controller 120 generates a control signal for commanding the display of the plurality of images corresponding to the read image data and outputs the generated control signal and the read image data to each the plurality of buttons 130. As a result, the plurality of buttons 130 display the plurality of images. In the present exemplary embodiment, an (X-Y)^{th}, where X and Y are natural numbers, display mode is a lower display mode of an X^{th} display mode. Thus, in FIGS. 4B through 4D, a category of a (1-1)^{th} display mode, a (1-2)^{th} display mode, and a (1-3)^{th} display mode, a category of a (2-1)^{th} display mode, a (2-2)^{th} display mode, and a (2-3)^{th} display mode, and a category of a (3-1)^{th} display mode, a (3-2)^{th} display mode, and a (3-3)^{th} display mode are distinguishable from each other. For example, the first display mode is a Korean input mode, the (1-1)^{th} display mode is a Korean consonant input mode, and the (1-2)^{th} display mode is a Korean vowel input mode. Likewise, the second display mode is an English input mode, the (2-1)^{th} display mode is an English lowercase letter input mode, and the (2-2)^{th} display mode is an English uppercase letter input mode.

FIG. 4A is a reference diagram of the first illustration for explaining the display principle according to an exemplary embodiment of the present invention.

According to the first illustration, the controller 120 determines whether an analyzed trajectory is a first or second predetermined trajectory. If it is determined that the analyzed trajectory is the first predetermined trajectory, the plurality of buttons 130 update a plurality of currently displayed images in correspondence to the plurality of currently displayed images. If it is determined that the analyzed trajectory is the second predetermined trajectory, the plurality of buttons 130 display the plurality of currently displayed images as before.

To do this, if it is determined that the analyzed trajectory is the first predetermined trajectory, the controller 120 generates a control signal corresponding to the analyzed trajectory and to the plurality of images that are currently displayed on the plurality of buttons 130. If it is determined that the analyzed trajectory is the second predetermined trajectory, the controller 120 generates a control signal corresponding to the analyzed trajectory.

For example, if an analyzed touch direction is upwards or downwards, the plurality of images that are currently displayed on the plurality of buttons 130 are updated in correspondence to the plurality of currently displayed images. As illustrated in FIG. 4A, if the user rubs the plurality of buttons 130, which display a plurality of images belonging to the first display mode, that is upwards, the plurality of buttons 130 display a plurality of images belonging to the fourth display mode. Likewise, if the user rubs the plurality of buttons 130, which display a plurality of images belonging to the second display mode, that is downwards, the plurality of buttons 130 display a plurality of images belonging to a third display mode.

However, if the analyzed touch direction is leftwards, the plurality of images that are currently displayed on the plurality of buttons 130 are updated irrespective of the plurality of currently displayed images. As illustrated in FIG. 4A, if the user rubs the plurality of buttons 130 leftwards, the plurality of buttons 130 display the plurality of images belonging to the first display mode irrespective of whether the plurality of currently displayed images belong to the second display mode, the third display mode, or the fourth display mode.

As a result, in FIG. 4A, each of the upward touch direction and the downward touch direction corresponds to the first predetermined trajectory, and the leftward touch direction corresponds to the second predetermined trajectory.

FIG. 4B is a reference diagram of the second illustration for explaining the display principle according to an exemplary embodiment of the present invention.

According to the second illustration, the controller 120 determines whether an analyzed trajectory is the first or second predetermined trajectory. If it is determined that the analyzed trajectory is the first predetermined trajectory, the plurality of buttons 130 update a plurality of currently displayed images by changing a category to which the plurality of currently displayed images belong. If it is determined that the analyzed trajectory is the second predetermined trajectory, the plurality of buttons 130 update the plurality of currently displayed images by maintaining the category to which the plurality of currently displayed images belong.

In detail, if an analyzed touch direction is upwards, a plurality of images that are currently displayed on the plurality of buttons 130 are updated to a plurality of images belonging to a different category from a category to which the plurality of currently displayed images belong. As illustrated in FIG. 4B, if the user rubs the plurality of buttons 130, which display a plurality of images belonging to the (1-2)^{th} display mode, that is upwards, the plurality of buttons 130 display a plurality of images belonging to the third display mode. Here, since the plurality of images belonging to the third display mode can be a plurality of images belonging to the (3-1)^{th} display mode, the (3-2)^{th} display mode, or the (3-3)^{th} display mode, the plurality of buttons 130 may display the plurality of images belonging to a display mode pre-set as a default mode, e.g., the (3-2)^{th} display mode, from among the (3-1)^{th} display mode, the (3-2)^{th} display mode, and the (3-3)^{th} display mode.

Likewise, if the analyzed touch direction is downwards, the plurality of images that are currently displayed on the plurality of buttons 130 are updated to the plurality of images belonging to a different category from the category to which the plurality of currently displayed images belong. As illustrated in FIG. 4B, if the user rubs the plurality of buttons 130, which display a plurality of images belonging to the (1-3)^{th} display mode, that is downwards, the plurality of buttons 130 display a plurality of images belonging to the second display mode. Here, since the plurality of images belonging to the second display mode can be a plurality of images belonging to the (2-1)^{th} display mode, the (2-2)^{th} display mode, or the (2-3)^{th} display mode, the plurality of buttons 130 may display the plurality of images belonging to a display mode pre-set as the default mode, e.g., the (2-3)^{th} display mode, from among the (2-1)^{th} display mode, the (2-2)^{th} display mode, and the (2-3)^{th} display mode.

However, if the analyzed touch direction is leftwards or rightwards, the plurality of images that are currently displayed on the plurality of buttons 130 are updated by maintaining a category to which the plurality of currently displayed images belong. As illustrated in FIG. 4B, if the user rubs the plurality of buttons 130, which display the plurality of images belonging to the (3-2)^{th} display mode, that is leftwards, the plurality of buttons 130 display the plurality of images belonging to the (3-3)^{th} display mode. In the same manner, if the user rubs the plurality of buttons 130, which display the plurality of images belonging to the (2-3)^{th} display mode, that is rightwards, the plurality of buttons 130 display the plurality of images belonging to the (2-2)^{th} display mode.

As a result, in FIG. 4B, each of the upward touch direction and the downward touch direction corresponds to the first predetermined trajectory, and each of the leftward touch direction and the rightward touch direction corresponds to the second predetermined trajectory.

FIG. 4C is a reference diagram of the third illustration for explaining the display principle according to an exemplary embodiment of the present invention.

According to the third illustration, a category to which a plurality of images displayed on the plurality of buttons 130 belong is determined in accordance with sensed locations forming an analyzed trajectory.

According to the third illustration, even if both certain analyzed trajectories (i.e., touch directions) are the same, if the sensed locations forming each of the analyzed trajectories are different from each other, the controller 120 can generate different control signals for both analyzed trajectories.

In detail, the controller 120 determines whether the analyzed trajectory is the first or second predetermined trajectory. If it is determined that the analyzed trajectory is the first predetermined trajectory, the plurality of buttons 130 display a plurality of images corresponding to a category corresponding to sensed locations forming the analyzed trajectory. If it is determined that the analyzed trajectory is the second predetermined trajectory, the plurality of buttons 130 update a plurality of currently displayed images by maintaining a category to which the plurality of currently displayed images belong.

If it is determined that the analyzed trajectory is the first predetermined trajectory, the controller 120 generates a control signal corresponding to the sensed locations forming the analyzed trajectory. If it is determined that the analyzed trajectory is the second predetermined trajectory, the controller 120 generates a control signal corresponding to the analyzed trajectory and to a plurality of images that are currently displayed on the plurality of buttons 130.

For example, if the analyzed touch direction is upwards or downwards, a plurality of images that are currently displayed on the plurality of buttons 130 are updated to a plurality of images belonging to a category corresponding to the sensed locations forming the analyzed touch direction. As illustrated in FIG. 4C, if the user rubs the touch sensors 318, 320, 322, and 324 that are disposed on a second column, the plurality of buttons 130, which display a plurality of images belonging to the (1-2)^{th} display mode, display a plurality of images belonging to the second display mode. Here, since the plurality of images belonging to the second display mode can be a plurality of images belonging to the (2-1)^{th} display mode, the (2-2)^{th} display mode, or the (2-3)^{th} display mode, the plurality of buttons 130 may display the plurality of images belonging to a display mode pre-set as a default mode, e.g., the (2-2)^{th} display mode, from among the (2-1)^{th} display mode, the (2-2)^{th} display mode, and the (2-3)^{th} display mode. In the same manner, if the user rubs the touch sensors 310, 312, 314, and 316 disposed on a first column, the plurality of buttons 130, which display a plurality of images belonging to the (3-2)^{th} display mode, display a plurality of images belonging to the first display mode. Here, since the plurality of images belonging to the first display mode can be a plurality of images belonging to the (1-1)^{th} display mode, the (1-2)^{th} display mode, or the (1-3)^{th} display mode, the plurality of buttons 130 may display the plurality of images belonging to a display mode pre-set as a default mode, e.g., the (1-1)^{th} display mode, from among the (1-1)^{th} display mode, the (1-2)^{th} display mode, and the (1-3)^{th} display mode.

However, if the analyzed touch direction is leftwards or rightwards, a plurality of images that are currently displayed on the plurality of buttons 130 are updated by maintaining a category to which the plurality of currently displayed images belong. As illustrated in FIG. 4C, if the user rubs the plurality of buttons 130 leftwards, the plurality of buttons 130, which display the plurality of images belonging to the (3-2)^{th} display mode, display a plurality of images belonging to the (3-3)^{th} display mode. In the same manner, if the user rubs the plurality of buttons 130 rightwards, the plurality of buttons 130, which display the plurality of images belonging to the (2-3)^{th} display mode, display the plurality of images belonging to the (2-2)^{th} display mode.

As a result, in FIG. 4C, each of the upwards touch direction and the downwards touch direction corresponds to the first predetermined trajectory, and each of the leftwards touch direction and the rightwards touch direction corresponds to the second predetermined trajectory.

FIG. 4D is a reference diagram of the fourth illustration for explaining the display principle according to an exemplary embodiment of the present invention.

According to the fourth illustration, a category to which a plurality of images displayed on the plurality of buttons 130 belong is determined in accordance with sensed locations forming an analyzed trajectory.

According to the fourth illustration, even if both certain analyzed trajectories (i.e., touch directions) are the same, if the sensed locations forming each of the analyzed trajectories are different from each other, the controller 120 can generate different control signals for both analyzed trajectories.

As illustrated in FIG. 4D, if the user rubs the touch sensors 310, 312, 314, and 316 disposed on the first column, the plurality of buttons 130 display a plurality of images belonging to the first display mode. Here, since the plurality of images belonging to the first display mode can be a plurality of images belonging to the (1-1)^{th} display mode, the (1-2)^{th} display mode, or the (1-3)^{th} display mode, the plurality of buttons 130 may display a plurality of images belonging to a display mode pre-set as a default mode, e.g., the (1-3)^{th} display mode, from among the (1-1)^{th} display mode, the (1-2)^{th} display mode, and the (1-3)^{th} display mode.

In the same manner, if the user rubs the touch sensors 310, 312, 314, and 316 disposed in the first column, the plurality of buttons 130, which display the plurality of images belonging to the (1-3)^{th} display mode, display a plurality of images belonging to the (1-1)^{th} display mode or the (1-2)^{th} display mode.

In another way, if the user rubs the touch sensors 318, 320, 322, and 324 disposed in the second column, the plurality of buttons 130, which display the plurality of images belonging to the (1-3)^{th} display mode, display a plurality of images belonging to the second display mode. Here, since the plurality of images belonging to the second display mode can be a plurality of images belonging to the (2-1)^{th} display mode, the (2-2)^{th} display mode, or the (2-3)^{th} display mode, the plurality of buttons 130 may display a plurality of images belonging to a display mode pre-set as a default mode, e.g., the (2-1)^{th} display mode, from among the (2-1)^{th} display mode, the (2-2)^{th} display mode, and the (2-3)^{th} display mode.

In another way, if the user rubs the touch sensors 326, 328, 330, and 332 disposed on a third column, the plurality of buttons 130, which display the plurality of images belonging to the (1-3)^{th} display mode, display a plurality of images belonging to the third display mode. Here, since the plurality of images belonging to the third display mode can be a plurality of images belonging to the (3-1)^{th} display mode, the (3-2)^{th} display mode, or the (3-3)^{th} display mode, the plurality of buttons 130 may display a plurality of images belonging to a display mode pre-set as a default mode, e.g., the (3-2)^{th} display mode, from among the (3-1)^{th} display mode, the (3-2)^{th} display mode, and the (3-3)^{th} display mode.

FIG. 4E is a reference diagram of the fifth illustration for explaining the display principle according to an exemplary embodiment of the present invention.

According to the fifth illustration, if the number of a plurality of images that are to be displayed on the plurality of buttons 130 is greater than the number of the plurality of buttons 130, the plurality of buttons 130 interchange the plurality of images in order to display the plurality of images on the plurality of buttons 130.

In FIG. 4E, each rectangle denotes an image displayed on the belonging buttons 130. The 12 rectangles 410, 420, 430, or 440 that are selected from among 108 rectangles indicate images displayed by the first through twelfth buttons 205, 210, 215, 220, 225, 230, 235, 240, 245, 250, 255, and 260.

For example, if it is assumed that the first display mode is the Korean input mode, the second display mode is the English input mode, the third display mode is a special character input mode, a lower display mode of each of the first, second, and third display modes does not exist, a display mode corresponding to an analyzed trajectory is the third display mode, and the number of images belonging to the third display mode is 108 images, the plurality of buttons 130 try to display 108 images.

However, the first through twelfth buttons 205, 210, 215, 220, 225, 230, 235, 240, 245, 250, 255, and 260 can display only 12 images. In this case, if the user presses one of the first through twelfth buttons 205, 210, 215, 220, 225, 230, 235, 240, 245, 250, 255, and 260 for a predetermined time, the 12 displayed images are updated in correspondence to a location of the pressed button from among the first through twelfth buttons 205, 210, 215, 220, 225, 230, 235, 240, 245, 250, 255, and 260 and the predetermined time.

In FIG. 4E, if the user presses the first button 205 of the first through twelfth buttons 205, 210, 215, 220, 225, 230, 235, 240, 245, 250, 255, and 260, which have displayed 12 images 410 for the predetermined time, the first through twelfth buttons 205, 210, 215, 220, 225, 230, 235, 240, 245, 250, 255, and 260 display 12 images 420. In the same way, if the user presses the twelfth button 260 of the first through twelfth buttons 205, 210, 215, 220, 225, 230, 235, 240, 245, 250, 255, and 260, which have displayed 12 images 410 for the predetermined time, the first through twelfth buttons 205, 210, 215, 220, 225, 230, 235, 240, 245, 250, 255, and 260 display 12 images 430. In the same way, if the user presses the eighth button 240 of the first through twelfth buttons 205, 210, 215, 220, 225, 230, 235, 240, 245, 250, 255, and 260, which have displayed 12 images 410, or the predetermined time, the first through twelfth buttons 205, 210, 215, 220, 225, 230, 235, 240, 245, 250, 255, and 260 display 12 images 440.

FIGS. 5A through 5G are reference diagrams for explaining a process of sending a short message, [symbol] Coffee [symbol] [symbol] , using the flip-type cellular phone 200 illustrated in FIG. 2, according to an exemplary embodiment of the present invention.

FIGS. 5A through 5G are described with reference to the second and fifth illustrations illustrated in FIGS. 4B and 4E.

In FIG. 4B, it is assumed that the first display mode is the Korean input mode, the (1-1)^{th} display mode is the Korean consonant input mode, the (1-2)^{th} display mode is the Korean vowel input mode, the second display mode is the English input mode, the (2-1)^{th} display mode is the English lowercase letter input mode, the (2-2)^{th} display mode is the English uppercase letter input mode, the third display mode is the special character input mode, the (3-1)^{th} display mode is a symbol input mode, the (3-2)^{th} display mode is an emoticon input mode, and the (3-3)^{th} display mode is a number input mode.

If the plurality of buttons 130 display a plurality of images of a category different from a category to which the (3-3)^{th} display mode belongs, e.g., display a plurality of images belonging to the (2-2)^{th} display mode (referring to FIG. 5D), the user has to rub the plurality of buttons 130 downwards so that a plurality of images belonging to the third display mode are displayed. In the present exemplary embodiment, if a default mode of the (3-1)^{th} display mode, the (3-2)^{th} display mode, and the (3-3)^{th} display mode is not set to the (3-3)^{th} display mode but another display mode, e.g., the (3-1)^{th} display mode, the user has to rub the plurality of buttons 130 rightwards so that the plurality of buttons 130 can display numbers (referring to FIG. 5G).

If the plurality of buttons 130 display a plurality of images, excluding a plurality of images belonging to the (3-3)^{th} display mode, but of the same category as a category to which the (3-3)^{th} display mode belongs, e.g., display a plurality of images belonging to the (3-2)^{th} display mode (referring to FIG. 5E), the user has to rub the plurality of buttons 130 leftwards so that the plurality of buttons 130 display numbers (referring to FIG. 5G).

When the numbers are displayed on the plurality of buttons 130 through the above-described procedures, the user inputs ‘5’ by pressing the sixth button 230.

Thereafter, the user should rub the plurality of buttons 130, which display the numbers, downwards so that the plurality of buttons 130 display a plurality of images belonging to the first display mode. Here, if a default mode of the (1-1)^{th} display mode and the (1-2)^{th} display mode is not set to the (1-1)^{th} display mode but the (1-2)^{th} display mode, the user should rub the plurality of buttons 130, which display Korean Vowels, rightwards so that the plurality of buttons 130 display Korean consonants (referring to FIG. 5A).

When the Korean consonants are displayed on the plurality of buttons 130 through the above-described procedures, the user inputs [symbol] by pressing the third button 215. Thereafter, the user should rub the plurality of buttons 130, which display the Korean consonants, leftwards so that the plurality of buttons 130 display the Korean vowels (referring to FIG. 5B).

When the Korean vowels are displayed on the plurality of buttons 130 through the above-described procedure, the user inputs [symbol] by pressing the first button 205. Thereafter, the user should rub the plurality of buttons 130, which display the Korean vowels, rightwards so that the plurality of buttons 130 display the Korean consonants (referring to FIG. 5A).

When the Korean consonants are displayed on the plurality of buttons 130 through the above-described procedure, the user inputs [symbol] by pressing the seventh button 235. Thereafter, the user should rub the plurality of buttons 130, which display the Korean consonants, leftwards so that the plurality of buttons 130 display the Korean vowels (referring to FIG. 5B).

When the Korean vowels are displayed on the plurality of buttons 130 through the above-described procedure, the user tries to input [symbol] . However, [symbol] is not displayed in FIG. 5B. Thus, the user should continuously press one of the first through twelfth buttons 205, 210, 215, 220, 225, 230, 235, 240, 245, 250, 255, and 260 illustrated in FIG. 5B so that [symbol] is included in a plurality of images displayed on the plurality of buttons 130. When [symbol] is finally displayed, the user inputs [symbol] .

Thereafter, the user should rub the plurality of buttons 130, which display the Korean vowels, downwards so that the plurality of buttons 130 display a plurality of images belonging to the second display mode. Here, if a default mode of the (2-1)^{th} display mode and the (2-2)^{th} display mode is not set to the (2-2)^{th} display mode, but the (2-1)^{th} display mode, the user should rub the plurality of buttons 130, which display English lowercase letters, leftwards so that the plurality of buttons 130 display English uppercase letters (referring to FIG. 5D).

When the English uppercase letters are displayed on the plurality of buttons 130 through the above-described procedures, the user inputs ‘C’ by pressing the ninth button 245. Thereafter, the user should rub the plurality of buttons 130, which display the English uppercase letters, rightwards so that the plurality of buttons 130 display the English lowercase letters (referring to FIG. 5C).

When the English lowercase letters are displayed on the plurality of buttons 130 through the above-described procedure, the user tries to input ‘o’. However, ‘o’ is not displayed in FIG. 5C. Thus, the user should continuously press one of the first through twelfth buttons 205, 210, 215, 220, 225, 230, 235, 240, 245, 250, 255, and 260 illustrated in FIG. 5C so that ‘o’ is included in a plurality of images displayed on the plurality of buttons 130. When ‘o’ is finally displayed, the user inputs ‘o’.

In the same manner, the user inputs ‘ffee’.

Thereafter, the user should rub the plurality of buttons 130, which display the English lowercase letters, upwards so that the plurality of buttons 130 display a plurality of images belonging to the first display mode. Here, if a default mode of the (1-1)^{th} and (1-2)^{th} display modes is not set to the (1-1)^{th} display mode, but the (1-2)^{th} display mode, the user should rub the plurality of buttons 130, which display the Korean Vowels, rightwards so that the plurality of buttons 130 display the Korean consonants (referring to FIG. 5A).

When the Korean consonants are displayed on the plurality of buttons 130 through the above-described procedures, the user inputs [symbol] by pressing the seventh button 235. Thereafter, the user should rub the plurality of buttons 130, which display the Korean consonants, leftwards so that the plurality of buttons 130 display the Korean vowels (referring to FIG. 5B).

When the Korean vowels are displayed on the plurality of buttons 130 through the above-described procedure, the user inputs [symbol] by pressing the second button 210. Thereafter, the user should rub the plurality of buttons 130, which display the Korean vowels, rightwards so that the plurality of buttons 130 display the Korean consonants (referring to FIG. 5A).

When the Korean consonants are displayed on the plurality of buttons 130 through the above-described procedure, the user tries to input [symbol] . However, [symbol] is not displayed in FIG. 5A. Thus, the user should continuously press one of the first through twelfth buttons 205, 210, 215, 220, 225, 230, 235, 240, 245, 250, 255, and 260 illustrated in FIG. 5A so that [symbol] is included in a plurality of images displayed on the plurality of buttons 130. When [symbol] is finally displayed, the user inputs [symbol] .

Thereafter, the user should rub the plurality of buttons 130, which display the Korean consonants, leftwards so that the plurality of buttons 130 display the Korean vowels (referring to FIG. 5B).

When the Korean vowels are displayed on the plurality of buttons 130 through the above-described procedure, the user inputs [symbol] by pressing the tenth button 250.

Thereafter, the user should rub the plurality of buttons 130, which display the Korean vowels, upwards so that the plurality of buttons 130 display a plurality of images belonging to the third display mode are displayed. Here, if a default mode of the (3-1)^{th} display mode, the (3-2)^{th} display mode, and the (3-3)^{th} display mode is set to the (3-1)^{th} display mode, the plurality of buttons 130 display symbols (referring to FIG. 5E).

When the symbols are displayed on the plurality of buttons 130 through the above-described procedure, the user inputs ‘?’ by pressing the sixth button 230. Thereafter, the user should rub the plurality of buttons 130, which display the symbols, leftwards so that the plurality of buttons 130 display emoticons (referring to FIG. 5F).

When the emoticons are displayed on the plurality of buttons 130 through the above-described procedure, the user inputs [symbol] by pressing the first button 205.

According to the same principle as described above, the reference diagrams illustrated in FIGS. 5A through 5G can be described using the first and fifth illustrations illustrated in FIGS. 4A and 4E, the third and fifth illustrations illustrated in FIGS. 4C and 4E, or the fourth and fifth illustrations illustrated in FIGS. 4D and 4E.

However, in order to describe the reference diagrams illustrated in FIGS. 5A through 5G using the first and fifth illustrations illustrated in FIGS. 4A and 4E, lower display modes should not exist in the first display mode, i.e., the Korean input mode, the second display mode, i.e., the English input mode, or the third display mode, i.e., the special character input mode. In this case, if the Korean consonants illustrated in FIG. 5A are displayed on the plurality of buttons 130, the user can continuously press one of the first through twelfth buttons 205, 210, 215, 220, 225, 230, 235, 240, 245, 250, 255, and 260 illustrated in FIG. 5A to display the Korean vowels illustrated in FIG. 5B on the plurality of buttons 130. In the same way, if the English lowercase letters illustrated in FIG. 5C are displayed on the plurality of buttons 130, the user can continuously press one of the first through twelfth buttons 205, 210, 215, 220, 225, 230, 235, 240, 245, 250, 255, and 260 illustrated in FIG. 5C to display the English uppercase letters illustrated in FIG. 5D on the plurality of buttons 130. In the same way, if the symbols illustrated in FIG. 5E are displayed on the plurality of buttons 130, the user can continuously press one of the first through twelfth buttons 205, 210, 215, 220, 225, 230, 235, 240, 245, 250, 255, and 260 illustrated in FIG. 5E to display the emoticons illustrated in FIG. 5F or the numbers illustrated in FIG. 5G on the plurality of buttons 130.

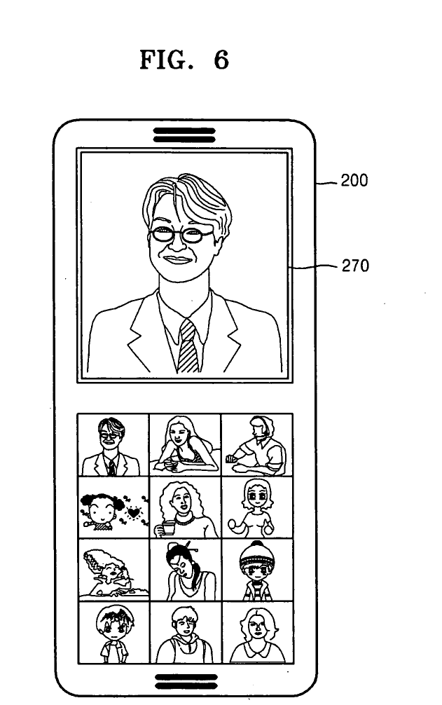

FIG. 6 is a reference diagram for explaining a browsing process using the flip-type cellular phone 200 illustrated in FIG. 2, according to an exemplary embodiment of the present invention. FIG. 6 is described with reference to FIGS. 1 and 4E.

The storage unit 140 can store image data indicating input information, e.g., letters, based on a display mode in the device but does not store image data indicating non-input information, e.g., still images, such as photographs or moving pictures, based on a display mode.

In FIG. 6, it is assumed that 108 photographs are stored in the flip-type cellular phone 200. Since the first through twelfth buttons 205, 210, 215, 220, 225, 230, 235, 240, 245, 250, 255, and 260 can display a maximum of twelve (12) photographs, in order to browse the 108 photographs using the first through twelfth buttons 205, 210, 215, 220, 225, 230, 235, 240, 245, 250, 255, and 260, 12 photographs displayed in the 12 buttons at a time must be variable.

To do this, the user can continuously press a certain button for a predetermined time or rub a plurality of buttons in a certain direction.

For example, if the user presses the first button 205 for the predetermined time or rubs buttons in a direction from the sixth button 230 to the first button 205, the first through twelfth buttons 205, 210, 215, 220, 225, 230, 235, 240, 245, 250, 255, and 260, which have displayed twelve (12) photographs 410, display another set of twelve (12) photographs 420. In the same way, if the user presses the twelfth button 260 for the predetermined time or rubs buttons in a direction from the seventh button 235 to the twelfth button 260, the first through twelfth buttons 205, 210, 215, 220, 225, 230, 235, 240, 245, 250, 255, and 260, which have displayed the 12 photographs 410, display another set of 12 photographs 430. In the same way, if the user presses the eighth button 240 for the predetermined time or rubs buttons in a direction from the sixth button 230 to the eighth button 240, the first through twelfth buttons 205, 210, 215, 220, 225, 230, 235, 240, 245, 250, 255, and 260, which have displayed the 12 photographs 410, display another set of 12 photographs 440.

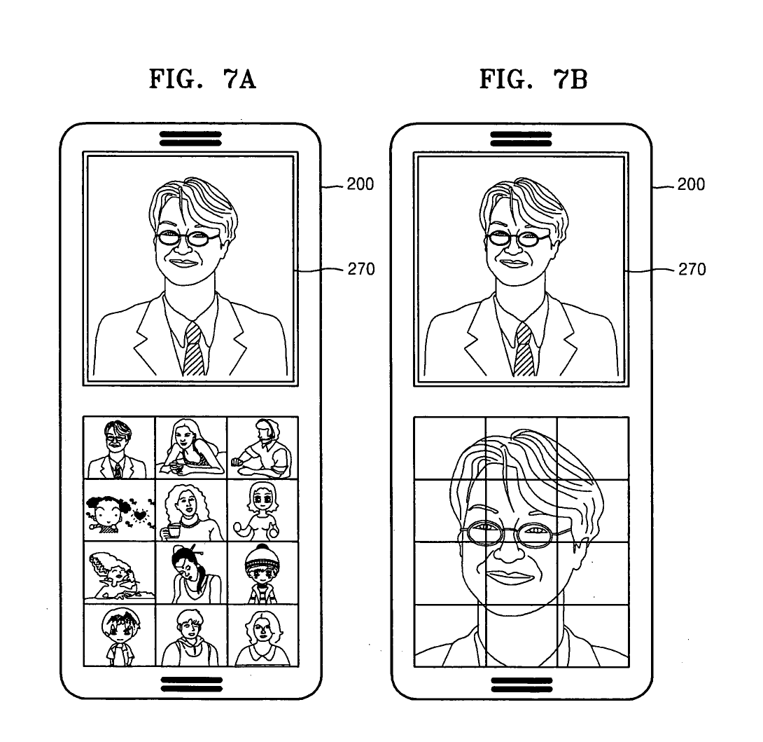

FIG. 7 is an illustration displayed by magnifying an image selected from among a plurality of images displayed on the first through twelfth buttons 205, 210, 215, 220, 225, 230, 235, 240, 245, 250, 255, and 260 of the flip-type cellular phone 200 illustrated in FIG. 2, according to an exemplary embodiment of the present invention.

If the user selects a certain photograph, e.g., a photograph displayed on the first button 205, from among 12 photographs illustrated in FIG. 7A, the certain photograph can be displayed on the display window 270 or on the first through twelfth buttons 205, 210, 215, 220, 225, 230, 235, 240, 245, 250, 255, and 260 after being magnified as illustrated in FIG. 7B.

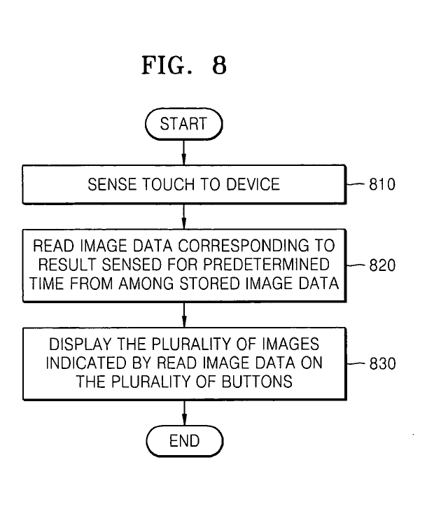

FIG. 8 is a flowchart illustrating a display method according to an exemplary embodiment of the present invention. The display method illustrated in FIG. 8 can include operations in which when a device is touched for a predetermined time, a plurality of images that are path structured pending on a touch are displayed on a plurality of buttons 130 included in the device (operations 810 through 830).

Referring to FIG. 8, the sensing unit 110 senses a touch to the device in operation 810. If the touch is continuously sensed for a predetermined time, the controller 120 reads image data corresponding to a result sensed for the predetermined time from the storage unit 140 in operation 820.

The plurality of buttons 130 display a plurality of images indicated by the read image data in operation 830.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions are stored/transferred and executed in a distributed fashion. The medium/media may also be the Internet. The computer readable code/instructions may be executed by one or more processors. The computer readable code/instructions may also be executed and/or embodied in at least one application specific integrated circuit (ASIC) or Field Programmable Gate Array (FPGA).

In addition, hardware devices may be configured to act as one or more software modules in order to perform the operations of the above-described exemplary embodiments.

The term “module” as used herein, denotes, but is not limited to, a software or hardware component, which performs certain tasks. A module may advantageously be configured to reside on the addressable storage medium/media and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and the modules can operate at least one processor (e.g. central processing unit (CPU)) provided in a device.

The computer readable code/instructions and computer readable medium/media may be those specially designed and constructed for the purposes of the present invention, or they may be of the kind well-known and available to those skilled in the art of computer hardware and/or computer software.

As described above, in a device having display buttons and a display method and medium for the device according to exemplary embodiments of the present invention, since the size of the buttons does not have to be reduced even if the number of functions available in the device increases, the convenience of the user when operating the buttons increases. In addition, since the function of the buttons interchanges without having to engrave the surface of the buttons, even a user who had experienced difficulty to identify the usage of the conventional buttons that were difficult to see due to the small engraving on the surface thereof, can easily identify the function of the buttons. Furthermore, since the function that the user currently desires to operate is identified and displayed on the buttons, the user does not have to repeatedly press the same button in order to operate a desired function. In addition, since the number of buttons included in the device can be significantly reduced, the market competitiveness of the device can increase as the size of the device decreases.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A display method performed in a device having a plurality of buttons, the method comprising:
(a) sensing a touch to the device including sensing locations where the touch has occurred; and
(b) displaying a plurality of images on the plurality of buttons, wherein operation (b) comprises:
(b1) analyzing a trajectory of the sensed locations; and
(b2) displaying a plurality of images, which are indicated by image data corresponding to the analyzed trajectory from among predetermined image data, on the plurality of buttons.

2. The method of claim 1, wherein the images are characters.

3. The method of claim 1, wherein operation (b1) comprises determining whether the analyzed trajectory is a first predetermined trajectory or a second predetermined trajectory, and wherein operation (b2) comprises:
(b21) if it is determined that the analyzed trajectory is the first predetermined trajectory, updating a plurality of currently displayed images in correspondence to the plurality of currently displayed images, and
(b22) if it is determined that the analyzed trajectory is the second predetermined trajectory, displaying the currently displayed images.

4. The method of claim 1, wherein operation (b1) comprises determining whether the analyzed trajectory is a first predetermined trajectory or a second predetermined trajectory, and wherein operation (b2) comprises:
(b21) if it is determined that the analyzed trajectory is the first predetermined trajectory, updating a plurality of currently displayed images by changing a category to which the plurality of currently displayed images belong, and
(b22) if it is determined that the analyzed trajectory is the second predetermined trajectory, updating the plurality of currently displayed images by maintaining the category to which the plurality of currently displayed images belong.

5. The method of claim 1, wherein operation (b2) comprises displaying the plurality of images corresponding to the sensed locations forming the analyzed trajectory on the plurality of buttons.

6. The method of claim 1, wherein the plurality of buttons magnify an image selected from among the plurality of displayed images and display the magnified image.

7. A device comprising:
a sensor to sense a touch to the device, wherein the sensor senses locations where the touch has occurred;
a plurality of buttons to display a plurality of images in response to a control signal; and
a controller to generate the control signal for commanding the display of images on the plurality of buttons, wherein the controller comprises:
a trajectory analyzer to analyze a trajectory of the sensed locations; and
a display controller to generate the control signal for commanding the display of images corresponding to the analyzed trajectory.

8. The device of claim 7, wherein the images are characters.

9. The device of claim 7, wherein the sensor comprises a plurality of touch sensors integrated as one unit with the buttons or a frame of the device.

10. The device of claim 7, wherein the plurality of buttons magnify an image selected from among the plurality of displayed images and display the magnified image.

11. At least one computer readable medium storing instructions that control at least one processor to perform a display method in a device having a plurality of buttons, the method comprising:
(a) sensing a touch to the device including sensing locations where the touch has occurred; and
(b) displaying a plurality of images on the plurality of buttons, wherein operation (b) comprises:
(b1) analyzing a trajectory of the sensed locations; and
(b2) displaying a plurality of images, which are indicated by image data corresponding to the analyzed trajectory from among predetermined image data, on the plurality of buttons

12. At least one computer readable medium as recited in claim 11, wherein the images are characters.

13. At least one computer readable medium as recited in claim 11, wherein operation (b1) comprises determining whether the analyzed trajectory is a first predetermined trajectory or a second predetermined trajectory, and wherein operation (b2) comprises:
(b21) if it is determined that the analyzed trajectory is the first predetermined trajectory, updating a plurality of currently displayed images in correspondence to the plurality of currently displayed images, and
(b22) if it is determined that the analyzed trajectory is the second predetermined trajectory, displaying the currently displayed images.

14. At least one computer readable medium as recited in claim 11, wherein operation (b1) comprises determining whether the analyzed trajectory is a first predetermined trajectory or a second predetermined trajectory, and wherein operation (b2) comprises:
(b21) if it is determined that the analyzed trajectory is the first predetermined trajectory, updating a plurality of currently displayed images by changing a category to which the plurality of currently displayed images belong, and
(b22) if it is determined that the analyzed trajectory is the second predetermined trajectory, updating the plurality of currently displayed images by maintaining the category to which the plurality of currently displayed images belong.

15. At least one computer readable medium as recited in claim 11, wherein operation (b2) comprises displaying the plurality of images corresponding to the sensed locations forming the analyzed trajectory on the plurality of buttons.

16. At least one computer readable medium as recited in claim 11, wherein the plurality of buttons magnify an image selected from among the plurality of displayed images and display the magnified image.

17. At least one computer readable medium as recited in claim 11, wherein the device is one of mobile devices including a cellular phone and a personal digital assistant.

18. The method of claim 1, wherein the device is one of mobile devices including a cellular phone and a personal digital assistant.

19. The device of claim 7, wherein the device is one of mobile devices including a cellular phone and a personal digital assistant.

20. The device of claim 7, wherein the sensor comprises a plurality of touch sensors.

21. The device of claim 7, wherein the sensor comprises a single touch sensor.
